(19) United States
(12) Patent Application Publication
(10) Pub. No.: US 2009/0207321 A1
(43) Pub. Date: Aug. 20, 2009

(54) IMAGE TRANSFER DEVICE, IMAGE DISPLAY APPARATUS, AND IMAGE DATA TRANSFER METHOD

(75) Inventor: Toru Karasawa, Kamiina-gun (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/369,797

(22) Filed: Feb. 12, 2009

(30) Foreign Application Priority Data
Feb. 15, 2008 (JP) 2008-034299

(51) Int. Cl. H04N 9/31

(52) U.S. Cl. 348/744; 348/E09.025

(57) ABSTRACT

An image transfer device which sequentially transfers successive image data to an image display apparatus via a network includes a memory unit which stores the image data and a control unit. The control unit transmits the image data to the image display apparatus during connection with the network, sequentially stores the continuing image data in the memory unit when detecting abnormal cut off of the network, and sequentially transfers the image data stored in the memory unit to the image display apparatus when detecting restoration of the network.

### CROSS REFERENCE TO RELATED APPLICATIONS

The present application claims priority from Japanese Patent Application No. 2008-034299 filed on Feb. 15, 2008, which is hereby incorporated by reference in its entirety.

### BACKGROUND

Currently, a projector which displays images based on image data transferred from a personal computer (hereinafter abbreviated as PC) via a wireless network is known. When moving images shown on a display of the PC are captured and successively transferred to the projector as capture data, for example, the projector produces images based on the received capture data and displays the images on a display screen (such as screen) as moving images corresponding to those shown on the display of the PC (see Japanese Patent Publication No. JP-A-2002-232706 and JP-A-2005-354639).

According to the known projector, however, the capture data is not transmitted from the PC when the wireless network is abnormally cut off during transfer of the successive image data (moving image data). In this case, no image to be displayed exists, and thus the display screen returns to the initial condition and displays logotype, for example.

During cut off of the wireless network, the PC continuously shows moving images on the display and captures and transmits the moving images from the PC. However, the capture data cannot reach the projector nor remain within the PC during cut off of the wireless network. Thus, the image to be displayed by the projector at the time of re-connection with the wireless network is not the image continuing from the time of abnormal cut off of the wireless network, but the next image containing no part which should be displayed on the PC during the period from abnormal cut off to restoration of the wireless network.

Thus, for displaying the image continuing from abnormal cut off of the wireless network after the wireless network is restored, the user needs to seek the image at the time of abnormal cut off of the wireless network, transfer the continuing image data, and execute associated processes by operating the PC. Thus, the user feels inconvenience in some cases.

This problem occurs not only when image data is transferred and displayed via the wireless network, but also when image data is transferred via a wire network. The problem further occurs not only in case of communication between PC and projector, but also communication between various types of image transmitting and receiving devices such as between PCs.

### SUMMARY

An embodiment of the disclosure may provide a technology capable of improving convenience for the user at the time of abnormal cut off of a network.

An image transfer device which sequentially transfers successive image data to an image display apparatus via a network according to at least one embodiment of the disclosure includes a memory unit which stores the image data and a control unit. The control unit sequentially transmits the image data to the image display apparatus during connection with the network, stores the continuing image data in the memory unit when detecting abnormal cut off of the network, and sequentially transfers the image data stored in the memory unit to the image display apparatus when detecting restoration of the network.

According to this structure, the image transfer device may transfer the image data continuing from abnormal cut off of the network to the image display apparatus at the time of restoration of the network even when the network is abnormally cut off during sequential transfer of successive image data to the image display apparatus. Thus, the image display apparatus may display images continuing after abnormal cut off of the network.

In this case, the user need not perform processes such as seeking the image at the time of abnormal cut off of the network and transferring the continuing image data by operating the image transfer device so as to display the image continuing from abnormal cut off of the network after restoration of the network. Thus, convenience for the user improves. The expression “abnormal cut off” refers not to cut off of a network in response to a command from the user but to cut off of a network due to external conditions or the like during connection with the network.

An image display apparatus which displays an image based on image data transferred from an image transfer device via a network according other embodiments of the disclosure includes an image display control unit. The image display control unit sequentially displays images based on the received image data during connection with the network, and displays the image shown at the time of detection of abnormal cut off of the network until restoration of the network when detecting abnormal cut off of the network.

According to this structure, the image display apparatus displays the image shown at the time of abnormal cut off of the network until restoration of the network when the network is abnormally cut off during successive reception and sequential display of the image data by the image display apparatus. By this method, the sense of incongruity for the user may be reduced by restoring the network and again displaying images based on the received image data compared with the case where the display image returns to the initial condition (such as display of logotype) at the time of abnormal cut off of the network, for example.

The disclosure is not limited to the image transfer device and the image display apparatus described above, but may be applied to various technologies such as image display system including the image transfer device and the image display apparatus, image data transfer method, image display method, and computer program.

### BRIEF DESCRIPTION OF THE DRAWINGS

Embodiments of the disclosure are described with reference to the accompanying drawings, wherein like reference numbers reference like elements.

FIG. 1 illustrates a concept of an image display system 1000 according to at least one embodiment of the disclosure.

FIG. 2 is a block diagram showing a general structure of a PC 100.

FIG. 3 is a block diagram showing a general structure of a projector 200.

FIG. 4 is a flowchart showing operation of the image display system 1000 according to the embodiment.

FIGS. 5A through 5C illustrate a concept of the operation of the image display system 1000 according to the embodiment.

### DESCRIPTION OF EMBODIMENT

An embodiment according to the disclosure is hereinafter described in the following order:

### A. Embodiment

A-1. Structure of Embodiment

A-2. Operation of Embodiment

A-3. Advantage of Embodiment

### B. Modified Example

### A. Embodiment

### A-1. Structure of Embodiment

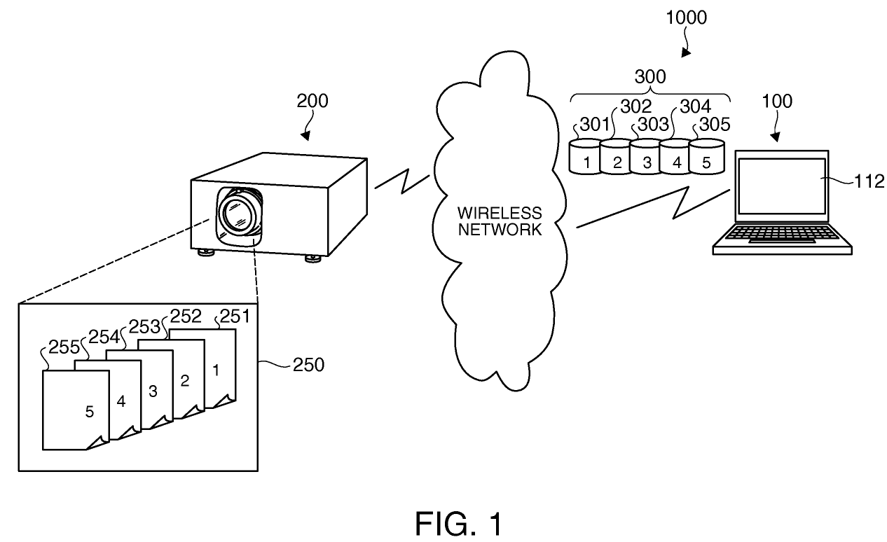

FIG. 1 illustrates a concept of an image display system 1000 according to this embodiment. As can be seen from the figure, the image display system 1000 includes a PC 100 as an image transfer device and a projector 200 as an image display apparatus. The PC 100 and the projector 200 are connected by pier-to-pier connection via a wireless network. The PC 100 captures display screen shown on a display 112 and transfers the captured screen as image data to the projector 200 via the wireless network. The image data as the captured display screen is hereinafter referred to as capture data 300. The projector 200 produces images corresponding to the capture data 300 received via the wireless network and projects the images on a screen 250.

In this embodiment, the PC 100 executes predetermined presentation software (such as Power Point; trademark of Microsoft Co.), and sequentially shows a series of images on the display 112 (generally called “slide show”). Simultaneously, the PC 100 captures display images and transfers the capture data to the projector 200. Thus, the projector 200 sequentially projects a series of images on the screen 250 in synchronization with the display screen of the PC 100. In this embodiment, the successive capture data produced by capturing the display images of the slide show corresponds to successive image data contained in the appended claims.

FIG. 1 shows an example which sequentially displays first through fifth images (images of slide show) on the display 112 of the PC 100 (first through fifth images are not shown) Capture data 301 corresponding to the captured first image shown on the display 112 is indicated by a cylindrical shape to which number “1” is given. Similarly, capture data 302 through 305 corresponding to the second through fifth images are indicated by cylindrical shapes to which corresponding numbers are given. An image displayed by the projector 200 and corresponding to the capture data 301 is indicated by an image 251 to which number “1” is given. Similarly, images 252 through 255 to which corresponding numbers are given correspond to the capture data 302 through 305. Thus, FIG. 1 illustrates a concept for sequentially transmitting the successive capture data 301 through 305 from the PC 100 and sequentially displays the successive images 251 through 255 by the projector 200 based on the received capture data.

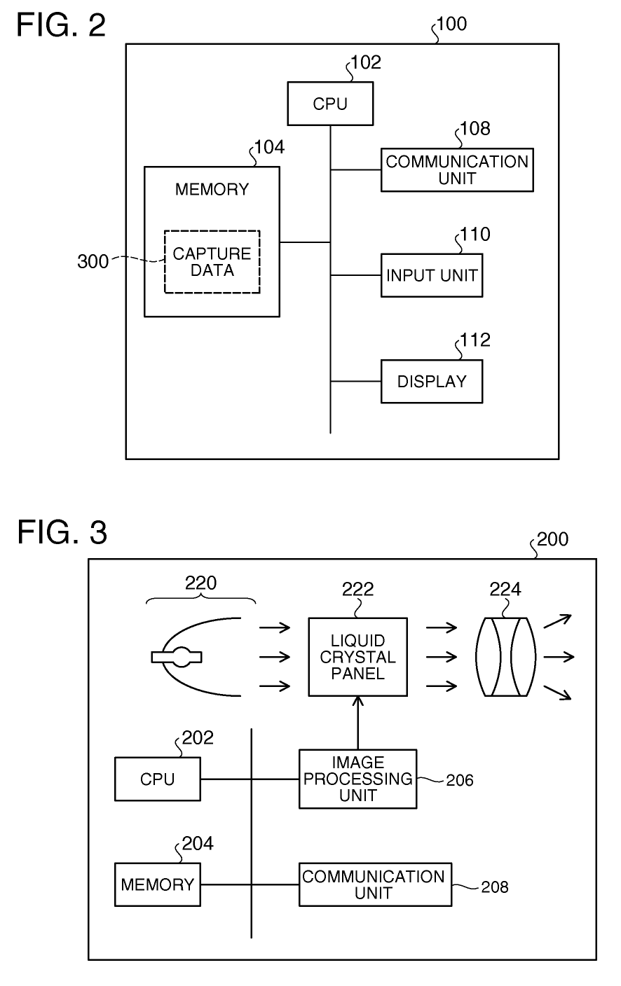

FIG. 2 is a block diagram showing the general structure of the PC 100. The PC 100 chiefly includes a CPU 102, a memory 104, a communication unit 108, an input unit 110, and the display 112, which are all connected via a bus. The CPU 102 performs various processes and controls under computer program stored in the memory 104. For example, the CPU 102 executes process for displaying images in the form of slide show according to the application program (such as Power Point) stored in the memory 104.

The memory 104 has ROM and RAM, and stores the computer program discussed above, data obtained during processing, and the like. As will be described later, the memory 104 stores the capture data 300 at the time of abnormal cut off of the wireless network.

The communication unit 108 has wireless LAN card, and can directly communicate with a communication unit 208 of the projector 200 via the wireless network. In this embodiment, the communication unit 108 transmits the capture data 300 to the projector 200 as discussed above, and can also transmit various types of data such as moving image data in the form of MPEG and picture data in the form of JPEG.

The input unit 110 has key board, pointing device and others through which commands from the user and the like are inputted. The display 112 is constituted by a liquid crystal display for displaying images and the like. The CPU 102 and the memory 104 in this embodiment correspond to a control unit and a memory unit contained in the appended claims, respectively.

FIG. 3 is a block diagram showing the general structure of the projector 200. The projector 200 includes a CPU 202, a memory 204, an image processing unit 206, the communication unit 208, a light source lamp 220, a liquid crystal panel 222, and a projection system 224. The CPU 202, the memory 204, the image processing unit 206, and the communication unit 208 are connected via a bus. The projector 200 further includes an operation unit (not shown) having buttons, remote controller, and other components provided on the main body of the projector 200. The user can determine various settings associated with the projector 200 by operating the operation unit. The CPU 202 in this embodiment corresponds to an image display control unit contained in the appended claims.

The CPU 202 performs various processes and controls under a computer program stored in the memory 204. The communication unit 208 receives capture data transferred from the PC 100 via the wireless network. The image processing unit 206 applies image processing to the capture data received via the communication unit 208 and supplies the processed image data to the liquid crystal panel 222. The image processing unit 206 similarly applies image processing to image data received from external devices such as PC, DVD player, external memory, and others connected with connector for external connection (not shown).

The liquid crystal panel 222 modulates light emitted from the light source lamp 220 using image data given from the image processing unit 206, and releases light representing images. The projection system 224 projects light released from the liquid crystal panel 222 on the screen 250, thereby displaying images on the screen.

### A-2. Operation of Embodiment

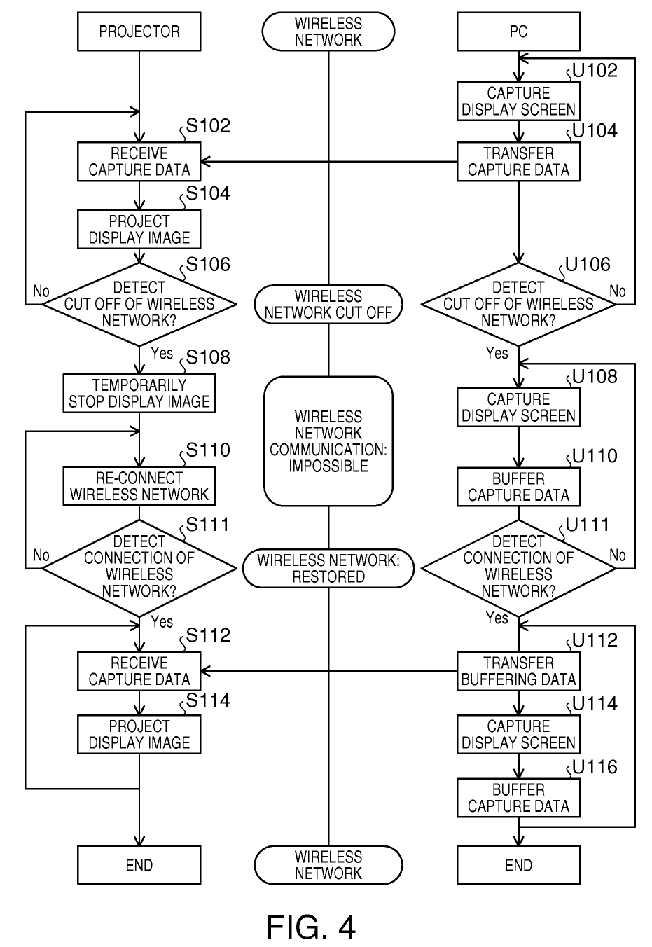

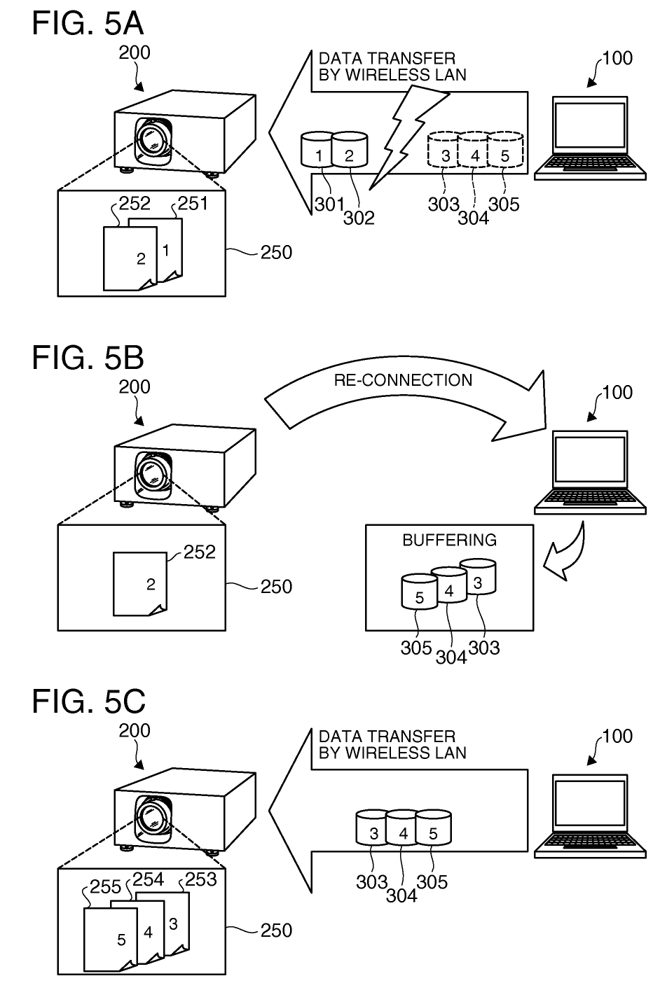

FIG. 4 is a flowchart showing operation of the image display system 1000 according to this embodiment. FIGS. 5A through 5C show five continuous capture data before and after abnormal cut off of the wireless network for clarifying the explanation.

This embodiment shows the operation of the image display system 1000 at the time of abnormal cut off of the wireless network while the projector 200 is projecting images on the screen 250 based on the capture data 300 transferred from the PC 100 via the wireless network.

Initially, the user starts the PC 100 and the projector 200 and initiates the application dedicated for the projector by operating the input unit 110 of the PC 100. Then, the CPU 102 of the PC 100 executes projector driver program stored in the memory 104. The PC 100 and the projector 200 negotiate with each other to establish connection via the wireless network.

Subsequently, the user starts application (such as Power Point) and inputs a command requiring display of slide show by operating the input unit 110. In response to the command, the CPU 102 of the PC 100 executes application program stored in the memory 104 to display slide show on the display 112.

The CPU 102 of the PC 100 captures the display screen in synchronization with switching to the screen of slide show (step U102), and transfers the capture data 300 to the projector 200 via the wireless network (step U104). When the communication unit 208 of the projector 200 receives the capture data (step S102), the CPU 202 issues a command requiring image processing to the image processing unit 206.

The image processing unit 206 applies various image processes to the received capture data, and supplies the processed image data to the liquid crystal panel 222. The projection system 224 projects light modulated based on the processed image data and released from the liquid crystal panel 222 on the screen 250. As a result, the same image as the display screen shown on the display 112 of the PC 100 is displayed on the screen 250 (step S104).

The CPU 102 and the CPU 202 constantly monitor the conditions of the wireless network including connection (such as connection in response to user's command and restoration after abnormal cut off) and cut off (such as cut off in response to user's command and abnormal cut off) of the wireless network. While the CPU 102 of the PC 100 is monitoring connection of the wireless network (NO in step U106), the CPU 102 repeats the steps U102 through U104. While the CPU 202 of the projector 200 is monitoring connection of the wireless network (NO in step S106), the CPU 202 repeats steps S102 through S104.

When the wireless network is abnormally cut off due to external conditions during successive transfer of the capture data from the PC 100 to the projector 200 (FIG. 5A), the CPU 102 of the PC 100 detects abnormal cut off of the wireless network via the communication unit 108 (YES in step U106). Similarly, the CPU 202 of the projector 200 detects abnormal cut off of the wireless network via the communication unit 208 (YES in step S106).

As illustrated in FIG. 5A, the capture data 301 and 302 are sequentially transferred before abnormal cut off of the wireless network. The projector 200 sequentially displays the images 251 and 252 based on the capture data 301 and 302.

The CPU 102 of the PC 100 continuously shows the corresponding slide show on the display 112 even after abnormal cut off of the wireless network. When detecting abnormal cut off of the wireless network (YES in step U106), the CPU 102 captures the display screen in the same manner (step U108) as before, and stores the capture data 300 in the buffer memory (RAM) of the memory 104 (step U110) as illustrated in FIG. 5B. Storing in the buffer memory is hereinafter referred to as buffering as well. As illustrated in FIG. 5B, the CPU 102 sequentially buffers the capture data 303, 304 and 305 in this order as continuation from the capture data 302 transferred immediately before abnormal cut off of the wireless network.

When detecting abnormal cut off of the wireless network (YES in step S106), the CPU 202 of the projector 200 continues projection of the images currently projected on the screen 250 (step S108). In the projector 200, the processed data as data produced by applying image processing to the received capture data using the image processing unit 206 is temporarily stored in the memory 204. Thus, the CPU 202 applies light representing the image to the liquid crystal panel 222 using the processed data corresponding to the capture data 302 received immediately before abnormal cut off of the wireless network and stored in the memory 204. As a result, the image 252 is displayed on the screen 250 by the function of the projection system 224 (FIG. 5B).

Then, the CPU 202 of the projector 200 performs process for re-connection with the wireless network via the communication unit 208 as illustrated in FIG. 5B (step S110). Since the CPU 202 does not detect connection with the wireless network until restoration of connection with the wireless network (NO in step S111), the CPU 202 repeats process for re-connection with the wireless network (step S110). When connection with the wireless network is restored, the CPU 102 of the PC 100 detects restoration of communication via the communication unit 108 (YES in step U111), and sequentially transfers the capture data stored in the buffer memory (hereinafter referred to as buffering data as well) to the projector 200. That is, the capture data 303, 304 and 305 as continuation of the capture data 302 after abnormal cut off of the wireless network are sequentially transferred in this order as illustrated in FIG. 5C.

The slide show is continuously shown on the display 112 after restoration of the wireless network. The CPU 102 captures display screen (step U114) to buffer the display screen (step U116), and sequentially transfers the buffering data to the projector 200. The buffering data transferred to the projector 200 is sequentially deleted from the memory 204 at predetermined time.

When detecting restoration of the wireless network via the communication unit 208 (YES in step S111), the CPU 202 of the projector 200 receives the capture data (step S112). Then, the CPU 202 projects an image corresponding to the received capture data on the screen 250 (step S114). That is, the image 253 corresponding to the capture data 303, the image 254 corresponding to the capture data 304, and the image 255 corresponding to the capture data 305 are sequentially displayed on the screen 250 in this order as illustrated in FIG. 5C.

While the wireless network is connected, the PC 100 repeats steps U112 through U114. Simultaneously, the projector 200 repeats steps S112 through S114. By this method, images are sequentially displayed on the screen 250.

### A-3: Advantage of Embodiment

According to the image display system 1000 in this embodiment, the image shown at the time of abnormal cut off of the wireless network (image 252 in FIGS. 5A through 5C) is displayed on the screen 250 even after abnormal cut off of the wireless network caused by external conditions. When the wireless network is restored, the images continuing after abnormal cut off of the wireless network (images 253, 254 and 255 in FIGS. 5A through 5C) are sequentially displayed. Thus, the user need not perform processes such as seeking the image at the time of abnormal cut off of the wireless network and transferring the continuing image data by operating the PC for display of the image continuing from abnormal cut off of the wireless network after restoration of the wireless network. Thus, convenience for the user improves.

Moreover, by the function of the projector 200 for automatic re-connection with the wireless network, connection with the wireless network is not required for the user. Thus, convenience for the user improves.

### B. Modified Example

The disclosure is not limited to the embodiment described and depicted herein, but may be practiced otherwise without departing from the scope and spirit of the disclosure.

(1) In the embodiment, the PC 100 captures the screen image of the slide show and transfers the continuous capture data to the projector 200. However, the continuous capture data is not limited to that used in the embodiment. For example, the PC 100 may reproduce DVD for image display, and capture the display screen to transfer the screen as continuous image data. Alternatively, moving image files in the form of MPEG or the like or still images in the form of JPEG or the like (such as picture data) may be successively transferred.

When moving image files are transferred from the PC 100 to the projector 200 via the wireless network, for example, a string of moving image files are divided into predetermined units and sequentially transferred by unit. At the time of abnormal cut off of the wireless network, advantages similar to those in the embodiment can be provided by buffering each unit of the moving image files. Particularly for transferring moving image files, a sense of incongruity caused by break of images may be reduced by displaying the image displayed on the screen by the projector 200 as it is after abnormal cut off of the wireless network.

For displaying moving image files such as movie by the projector 200, the PC 100 may thin out the image data after abnormal cut off of the wireless network at predetermined intervals and transfer the remaining image data. In this case, the projector 200 displays moving images similar to those reproduced by quick forward reproduction. Generally, the PC 100 continuously displays moving image files after abnormal cut off of the wireless network. Thus, time lag is produced between the display screen of the PC 100 and the display screen of the projector 200 when the projector 200 displays the continuing moving image file after restoration of the wireless network. However, by displaying moving images similar to those reproduced by quick forward reproduction on the projector 200 as discussed above, the display screen of the projector 200 catches up with the display screen of the PC 100 after elapse of predetermined time from restoration of the wireless network. When the display screen of the projector 200 overtakes the display screen of the PC 100, moving image files are transferred in the same manner as before abnormal cut off of the wireless network. By this method, moving images displayed by the projector 200 do not break at the time of abnormal cut off of the wireless network, and are again displayed by the projector in synchronization with the display screen of the PC 100.

(2) In the embodiment, the PC 100 and the projector 200 are used as the image transfer device and the image display apparatus, respectively. However, a PC having display screen maybe employed as the image display apparatus. Alternatively, an image receiver such as TV may be employed as the image display apparatus by using hard disk recorder or the like as the image transfer device. In these structures, advantages similar to those of the embodiment can be provided.

(3) In the embodiment, the PC 100 and the projector are connected with each other by pier-to-pier connection via the wireless network. However, the PC 100 and the projector may be connected via access point (base station). Alternatively, the PC 100 and the projector 200 maybe connected via wire network. In these structures, advantages similar to those of the embodiment can be provided.

(4) In the embodiment, the projector 200 executes re-connection with the wireless network after detecting abnormal cut off of the wireless network. However, re-connection may be conducted by the PC 100. Also, re-connection which is automatically performed according to the embodiment may be manually executed by the user.

What is claimed is:

1. An image transfer device which sequentially transfers successive image data to an image display apparatus via a network comprising:
a memory unit which stores the image data; and
a control unit,
wherein the control unit transfers the image data to the image display apparatus during connection with the network, sequentially stores the continuing image data in the memory unit when detecting abnormal cut off of the network, and sequentially transfers the image data stored in the memory unit to the image display apparatus when detecting restoration of the network.

2. The image transfer device according to claim 1, further comprising a display showing images, wherein the control unit shows images on the display, captures images shown on the display and transfers the successively captured images to the image display apparatus as image data via the network.

3. The image transfer device according to claim 1, wherein the control unit transfers a moving image file to the image display apparatus via the network.

4. The image transfer device according to claim 1, wherein the control unit thins out the image data stored in the memory unit at predetermined intervals and transfer the remaining image data to the image display apparatus when detecting restoration of the network.

5. An image display apparatus which displays an image based on image data transferred from an image transfer device via a network comprising:
an image display control unit,
wherein the image display control unit sequentially displays images based on the received image data during connection with the network, and displays the image shown at the time of detection of abnormal cut off of the network until restoration of the network when detecting abnormal cut off of the network.

6. A method for sequentially transferring successive image data from an image transfer device to an image display apparatus via a network comprising:
(a) sequentially transferring the image data to the image display apparatus via the network;
(b) detecting condition of the network;
(c) sequentially storing the continuing image data in a memory unit of the image transfer device when abnormal cut off of the network is detected in (b); and
(d) sequentially transferring the image data stored in the memory unit to the image display apparatus when restoration of the network is detected in (b).
